(19) United States
(12) Patent Application Publication
(10) Pub. No.: US 2022/0342837 A1
(43) Pub. Date: Oct. 27, 2022

(54) PERIPHERAL COMPONENT INTERCONNECT EXPRESS DEVICE AND OPERATING METHOD THEREOF

(71) Applicant: SK hynix Inc., Gyeonggi-do (KR)

(72) Inventor: Sarath Kumar Kunnumpurathu Sivan, Gyeonggi-do (KR)

(21) Appl. No.: 17/521,624

(22) Filed: Nov. 8, 2021

(30) Foreign Application Priority Data
Apr. 22, 2021 (KR) 10-2021-0052610

(51) Int. Cl. G06F 13/28; G06F 13/42

(52) U.S. Cl. CPC G06F 13/28; G06F 13/4282; G06F 2213/0026

(57) ABSTRACT

A Peripheral Component Interconnect express (PCIe) device may include at least one Direct Memory Access (DMA) device and a PCIe controller. The PCIe controller may count, in units of data blocks each having a predetermined size, an amount of data about target commands respectively allocated to multi-functions executed in the at least one DMA device, and determine, among the multi-functions, candidate functions to receive new commands from a host based on a result obtained by comparing the counted amount for each of the multi-functions with a threshold value.

### CROSS-REFERENCE TO RELATED APPLICATION

The present application claims priority under 35 U.S.C. § 119(a) to Korean patent application number 10-2021-0052610 filed on Apr. 22, 2021, the entire disclosure of which is incorporated by reference herein.

### BACKGROUND

### Field of Invention

The present disclosure generally relates to an electronic device, and more particularly, to a Peripheral Component Interconnect express (PCIe) device and an operating method thereof.

### Description of Related Art

A Peripheral Component Interconnect (PCI) is an interface having a serial structure, which is used for data communication. A PCIe-based storage device supports a multi-port and a multi-function. The PCIe-based storage device may be virtualized and non-virtualized, and achieve Quality of Service (QoS) of a host I/O command through one or more PCIe functions.

A storage device is a device which stores data under the control of a host device such as a computer or a smart phone. The storage device may include a memory device for storing data and a memory controller for controlling the memory device. The memory device is classified into a volatile memory device and a nonvolatile memory device.

The volatile memory device is a memory device in which data is stored only when power is supplied, and stored data disappears when the supply of power is interrupted. The volatile memory device may include a Static Random Access Memory (SRAM), a Dynamic Random Access Memory (DRAM), and the like.

The nonvolatile memory device is a memory device in which data does not disappear even when the supply of power is interrupted. The nonvolatile memory device may include a Read Only Memory (ROM), a Programmable ROM (PROM), an Electrically Programmable ROM (EPROM), an Electrically Erasable ROM (EEROM), a flash memory, and the like.

### SUMMARY

Embodiments of the present disclosure provide a Peripheral

Component Interconnect express (PCIe) device for providing uniform Quality of Service (QoS) for each function, and a computing system including the PCIe device.

In accordance with an aspect of the present disclosure, there is provided a PCIe device including: at least one Direct Memory Access (DMA) device; and a PCIe controller configured to count, in units of data blocks each having a predetermined size, an amount of data about target commands respectively allocated to multi-functions executed in the at least one DMA device, and determine, among the multi-functions, candidate functions to receive new commands from a host based on a result obtained by comparing the counted amount for each of the multi-functions with a threshold value.

In accordance with another aspect of the present disclosure, there is provided a method for operating a PCIe device including at least one DMA device, the method including: counting, in units of data blocks each having a predetermined size, an amount of data about target commands respectively allocated to multi-functions executed in the at least one DMA device; and determining, among the multi-functions, candidate functions to receive new commands from a host based on a result obtained by comparing the counted amount for each of the multi-functions with a threshold value.

### BRIEF DESCRIPTION OF THE DRAWINGS

Various embodiments of the present disclosure will now be described more fully hereinafter with reference to the accompanying drawings; however, the embodiments may be embodied in different forms and should not be construed as limited to the embodiments set forth herein. Rather, these embodiments are provided so that this disclosure will be thorough and complete, and will fully convey the scope of the example embodiments to those skilled in the art.

In the drawing figures, dimensions may be exaggerated for clarity of illustration. It will be understood that when an element is referred to as being “between” two elements, it can be the only element between the two elements, or one or more intervening elements may also be present. Like reference numerals refer to like elements throughout.

FIG. 1 is a diagram illustrating a structure and an operation of a Peripheral Component Interconnect express (PCIe) device in accordance with an embodiment of the present disclosure.

FIG. 2 is a diagram illustrating a traffic table such as that shown in FIG. 1 in accordance with an embodiment of the present disclosure.

FIG. 3 is a diagram illustrating a traffic table such as that shown in FIG. 1 in accordance with an embodiment of the present disclosure.

FIG. 4 is a diagram illustrating a candidate function and a waiting function in accordance with an embodiment of the present disclosure.

FIG. 5 is a flowchart illustrating an operation of the PCIe device in accordance with an embodiment of the present disclosure.

FIG. 6 is a flowchart illustrating an operation of the PCIe device in accordance with an embodiment of the present disclosure.

FIG. 7 is a flowchart illustrating an operation of the PCIe device in accordance with an embodiment of the present disclosure.

FIG. 8 is a flowchart illustrating an operation of the PCIe device in accordance with an embodiment of the present disclosure.

### DETAILED DESCRIPTION

The specific structural or functional description disclosed herein is merely illustrative for the purpose of describing embodiments according to the concept of the present disclosure. The embodiments according to the concept of the present disclosure can be implemented in various forms, and should not be construed as limited to the embodiments set forth herein.

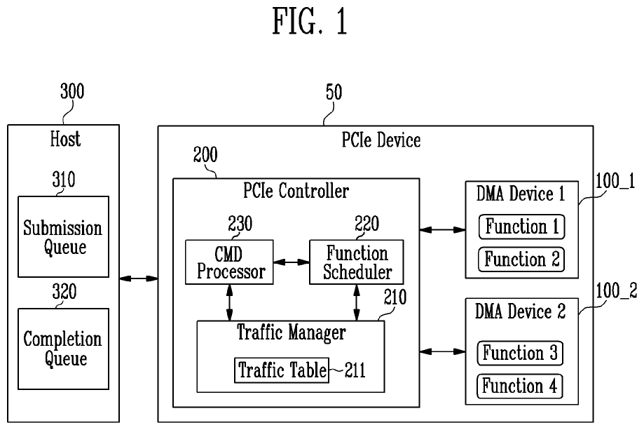

FIG. 1 is a diagram illustrating a structure and an operation of a Peripheral Component Interconnect express (PCIe) device in accordance with an embodiment of the present disclosure.

Referring to FIG. 1, the PCIe device 50 may include at least one Direct Memory Access (DMA) device and a PCIe controller 200.

The type of the DMA device may include a Non-Volatile Memory express (NVMe) device, a Solid State Drive (SSD) device, an Artificial Intelligence Central Processing Unit (AI CPU), an Artificial Intelligence System on Chip (AI SoC), an Ethernet device, a sound card, a graphic card, and the like. The type of the DMA device is not limited thereto, and may include other electronic devices using a PCIe interface.

The PCIe device 50 may generate a physical function. The PCIe device 50 may generate a virtual function according to a virtualization request received from a host 300. The PCIe device 50 may allocate the functions to each DMA device. The number of the functions allocated to each DMA device to be executed may be individually set. Therefore, a plurality of functions or multi-functions may be allocated to one DMA device, and each of the multi-functions may be executed as an independent operation unit. Each of the multi-functions may be software or firmware which is executed in the DMA device and processes a command received from the host 300 and data about the command. Processing the data may include a read operation for the data or a program operation of the data, according to the command.

In FIG. 1, the PCIe device 50 may include a PCIe controller 200 and first and second DMA devices 100_1 and 100_2.

First and second functions Function 1 and Function 2 may be executed in the first DMA device 100_1. Third and fourth functions Function 3 and Function 4 may be executed in the second first DMA device 100_2. The number of DMA devices included in the PCIe device 50 and the number of functions executed in each DMA device are not limited to this embodiment.

The PCIe controller 200 may process data about a command allocated to each function. For example, when the PCIe controller 200 processes data according to a read command, the PCIe controller 200 may provide the host 300 with data read from the DMA device. When the PCIe controller 200 processes data according to a write command, the PCIe controller 200 may provide the DMA device with write data received from the host 300.

In an embodiment, the PCIe controller 200 may include a traffic manager 210, a function scheduler 220, and a command (CMD) processor 230.

The traffic manager 210 may count, in units of data blocks each having a predetermined size, an amount of data about target commands allocated to each of the multi-functions. The traffic manager 210 may store a traffic table including the counted amount for each of the multi-functions.

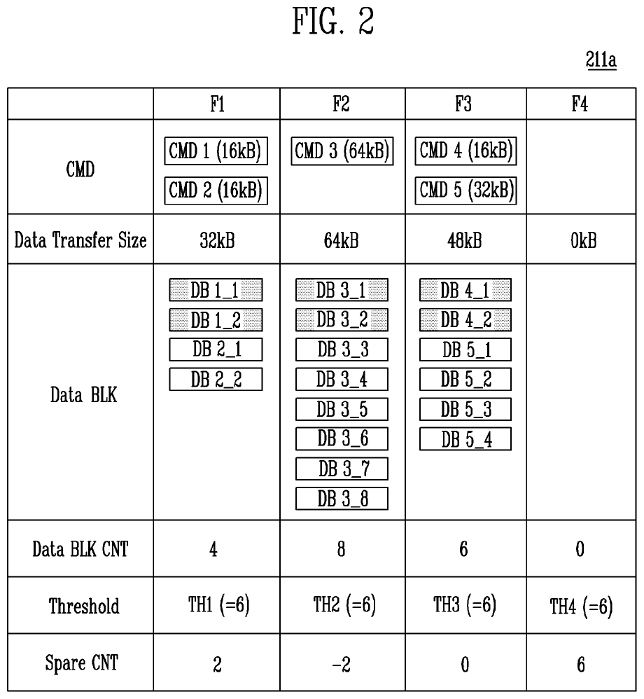

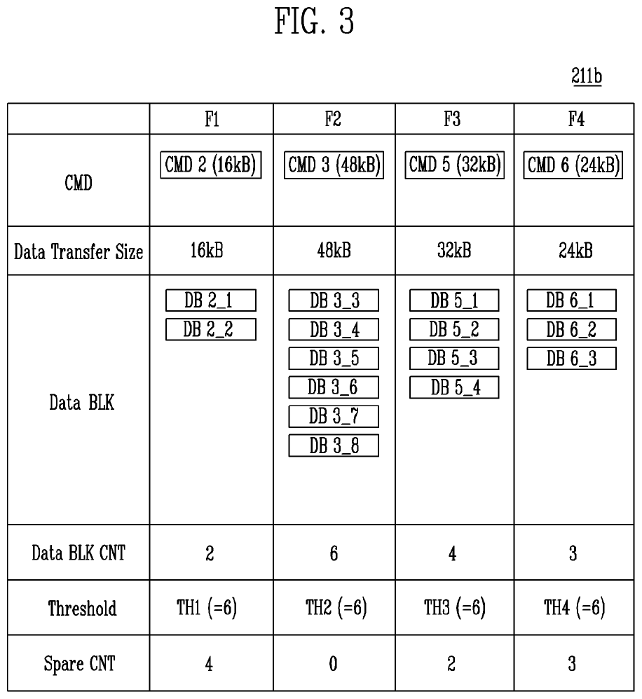

In FIG. 1, the traffic table 211 may include the counted amounts for the first to fourth functions Function 1 to Function 4. The traffic table 211 will be described later with reference to FIGS. 2 and 3.

The traffic manager 210 may update the traffic table 211, when the data blocks for target commands are processed. For example, the traffic manager 210 may decrease the counted amount for a function by as many as a number of processed data blocks for a command allocated to the corresponding function. The traffic manager 210 may update the traffic table 211, when a new command allocated to a function is fetched from the host 300. For example, the traffic manager 210 may increase the counted amount for the corresponding function by as many as a number obtained by converting, in the units of data blocks, an amount of data about the new command.

The traffic manager 210 may calculate an available traffic of each of the multi-functions based on a result obtained by comparing the counted amounts for each of the multi-functions with a threshold value. The occupancy of a function with respect to a resource of the PCIe device may become lower as the available traffic of the function becomes higher. The occupancy of the function with respect to a resource of the PCIe device may become higher as the available traffic of the function becomes lower.

The function scheduler 220 may determine candidate functions which are to receive new commands from the host among the multi-functions based on the result obtained by comparing the counted amount for each of the multi-functions with the threshold value.

The function scheduler 220 may determine, as the candidate functions, functions for which each of the counted amounts is less than the threshold value among the multi-functions. The function scheduler 220 may determine, as waiting functions, functions for which each of the counted amounts is greater than or equal to the threshold value among the multi-functions.

The function scheduler 220 may set a priority order between the candidate functions based on the available traffics of the candidate functions, which the traffic manager 210 calculates.

The command processor 230 may fetch, from the host 300, new commands allocated to the candidate functions. The command processor 230 may process, in the units of data blocks, data about target commands allocated to a function. The command processor 230 may provide the host 300 with completion information on a command about which the command processor 230 completes the processing of the data among the target commands.

The host 300 may include a submission queue 310 and a completion queue 320.

Both the submission queue 310 and the completion queue 320 may store command entries in a wrap structure. A start point of the stored command entries may be a head, and an end point may be a tail. The host 300 may notify a tail pointer of the submission queue 310 to the PCIe device 50 by writing a submission queue tail doorbell. The host 300 may notify a head pointer of the completion queue 320 to the PCIe device 50 by writing a completion queue head doorbell.

The submission queue 310 may store a command entry which the host 300 requests from the PCIe device 50. The PCIe device 50 may fetch a command allocated to a function based on the command entries stored in the submission queue 310. The PCIe device 50 may provide the host with completion information on the command, when processing of the command is completed. The host 300 may remove a command entry corresponding to the completion information from the completion queue 320.

In an embodiment, the function shown in FIG. 1 may be a PCIe function.

The PCIe function may become a Physical Function (PF) or a Virtual Function (VF). An allocation of PF or VF may be applied to both a virtualized storage device and a non-virtualized storage device, which support one or more PCIe functions. A multi-port and multi-function PCIe device may include one or more PCIe ports and one or more PCIe functions as the physical function or the virtual function. A storage device which supports PCIe-based virtualization may implement any of Single Root Input Output Virtualization (SR-IOV) and Multi Root Input Output Virtualization (MR-IOV).

The storage device may naturally share a resource through the PCIe-based virtualization. All resources such as a memory space, an I0 queue, interrupt for each interface, and command processing are intrinsically exposed to each PCIe function. Since an interface separated from each PCIe function is provided, the storage device can implement the SR-IOV or the MR-IOV simultaneously to receive a command from the host without having any middle layer interposed therebetween. Consequently, host latency can be decreased. Each PCIe function is independent and does not know any activity of another PCIe function.

Direct resource allocation in the PCIe-based virtualization provides very fast I/O and prevents sharing of I/O devices. The SR-ION/may provide a mechanism in which a single root function (e.g., a storage device) in a host machine is shown as a plurality of separated physical devices.

The physical function is a PCIe function of a storage device which supports an SR-ION/or MR-ION/interface. The physical function includes an extended capability of the SR-ION/in a PCIe configuration space. The capability may be used for configuration and management of SR-ION/functionality of the storage device, such as enabling of virtualization and exposure of the virtual function.

The virtual function is a lightweight PCIe function on the storage device which supports the SR-ION/or MR-ION/interface. The virtual function is associated with the PF on the storage device, and represents a virtualized instance of the storage device. Each virtual function has an intrinsic PCIe configuration space. Each virtual function may also share one or more physical resources on the storage device.

In a device which can implement SR-IOV, the physical function is first discovered, and the PCIe configuration space is read. Therefore, a host which can implement the SR-IOV may scan all virtual functions and list the scanned virtual functions. These virtual functions may be allocated to the virtual machine.

In an embodiment of the present disclosure, there is disclosed a scheme for providing constant Quality of Service (QoS) to all host entities which access the PCIe device through the PCIe function. That is, there is proposed a scheme for maintaining QoS in the multi-function and multi-port PCIe device. In order to ensure the constant QoS, the storage device is to sense a payload and access a pattern of each PCIe function.

FIG. 2 is a diagram illustrating a traffic table such as that shown in FIG. 1 in accordance with an embodiment of the present disclosure.

In FIG. 2, the traffic table 211a may include table block counts of first to fourth functions F1 to F4 at a time t1.

Commands (illustrated as “CMD” in FIG. 2) may be allocated to each of the first to fourth functions F1 to F4. First and second commands CMD 1 and CMD 2 may be allocated to the first function F1. A third command CMD 3 may be allocated to the second function F2. Fourth and fifth commands CMD 4 and CMD 5 may be allocated to the third function F3. No command may be allocated to the fourth function F4. The number of commands allocated to each function is not limited to this embodiment.

The size of data about a command may mean the size of the data transacted between a controller and a host according to the command. The size of data about the first command CMD 1 may be 16 kB. The size of data about the second command CMD 2 may be 16 kB. The size of data about the third command CMD 3 may be 64 kB. The size of data about the fourth command CMD 4 may be 16 kB. The size of data about the fifth command CMD 5 may be 32 kB. The size of data about each command is not limited to this embodiment.

The size of data about a command allocated to each function may be counted in the units of data blocks each having the predetermined size. The predetermined size may be 8 kB. The size of the unit of data block is not limited to this embodiment.

The total size (illustrated as “Data Transfer Size” in FIG. 2) of the data about the first and second commands CMD 1 and CMD 2 allocated to the first function F1 is 32 kB, and therefore, the counted amount (illustrated as “Data BLK CNT” in FIG. 2) for the first function F1 may be 4. The total size of the data about the third command CMD 3 allocated to the second function F2 is 64 kB, and therefore, the counted amount for the second function F2 may be 8. The total size of the data about the fourth and fifth commands CMD 4 and CMD 5 allocated to the third function F3 is 48 kB, and therefore, the counted amount for the third function F3 may be 6. No command is allocated to the fourth function F4, and therefore, the counted amount for the fourth function F4 may be 0.

In an embodiment, the same threshold value (illustrated as “Threshold” in FIG. 2) may be set for each function. In FIG. 2, first to fourth threshold values TH1 to TH4 respectively corresponding to the first to fourth functions F1 to F4 may all be equally set as 6.

An available traffic (illustrated as “Spare CNT” in FIG. 2) may be calculated based on a result obtained by comparing the counted amount for each function with the threshold value. The available traffic of the first function F1 may be 2 obtained by subtracting the counted amount of the value 4 from 6 as the first threshold value TH1. The available traffic of the second function F2 may be −2 obtained by subtracting the counted amount of the value 8 from 6 as the second threshold value TH2. The available traffic of the third function may be 0 obtained by subtracting the counted amount of the value 6 from 6 as the third threshold value TH3. The available traffic of the fourth function F4 may be 6 obtained by subtracting the counted amount of the value 0 from 6 as the fourth threshold value

TH4.

The amount of data which a function is to process becomes smaller as the available traffic of the function becomes larger, and therefore, the resource occupancy of the PCIe device 50 for the corresponding function may be low. The amount of data which a function is to process becomes larger as the available traffic of the function becomes smaller, and therefore, the resource occupancy of the PCIe device 50 for the corresponding function may be high.

In another embodiment, the threshold value may be differently set for each function according to a resource in the PCIe device 50 or a request of the host 300. In another embodiment, the threshold value may be differently set according to the DMA device in which each function is executed.

FIG. 3 is a diagram illustrating a traffic table such as that shown in FIG. 1 in accordance with an embodiment of the present disclosure.

Referring to FIG. 3, the traffic table 211b may include the counted amounts for first to the fourth functions F1 to F4 at a time t2. As compared with the traffic table 211a described with reference to FIG. 2, data blocks DB 1_1 and DB 1_2 for the first command CMD 1 are in a state in which the data blocks DB 1_1 and DB 1_2 have been completely processed (see “Data BLK” in FIGS. 2 and 3). Data blocks DB 3_1 and DB 3_2 among data blocks DB 3_1 to DB 3_8 for the third command CMD 3 are in a state in which the data blocks DB 3_1 and DB 3_2 have been completely processed. Data blocks DB 4_1 and DB 4_2 for the fourth command CMD 4 are in a state in which the data blocks DB 4_1 and DB 4_2 have been completely processed. A sixth command CMD 6 may be in a state in which the sixth command CMD 6 is allocated to the fourth function F4. The size of data about the sixth command CMD 6 may be 24 kB.

Therefore, as compared with the traffic table 211a, the counted amount for the first function F1 may decrease from 4 to 2. The counted amount for the second function F2 may decrease from 8 to 6. The counted amount for the third function F3 may decrease from 6 to 4. The counted amount for the fourth function F4 may increase from 0 to 3.

The available traffic of the first function F1 may increase from 2 to 4. The available traffic of the second function F2 may increase from −2 to 0. The available traffic of the third function F3 may increase from 0 to 2. The available traffic of the fourth function F4 may decrease from 6 to 3.

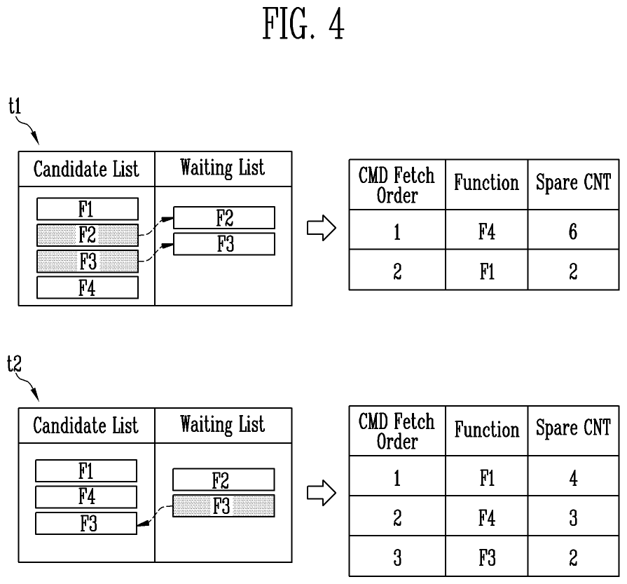

FIG. 4 is a diagram illustrating a candidate function and a waiting function in accordance with an embodiment of the present disclosure.

Referring to FIGS. 1 and 4, a command allocated to the candidate function may be fetched from the host 300. Therefore, the occupancy of a resource in the PCIe device 50 of the candidate function may increase. A command allocated to the waiting function cannot be fetched from the host 300. The occupancy of a resource in the PCIe device 50 of the waiting function may decrease.

At the time t1, referring to the traffic table 211a described with reference to FIG. 2, the counted amount for each of the first and fourth functions F1 and F4 is less than the threshold value, and hence the first and fourth functions F1 and F4 may be determined as the candidate functions. The counted amount for each of the second and third functions F2 and F3 is greater than or equal to the threshold value, and hence the second and third functions F2 and F3 may be determined as the waiting functions. Therefore, only commands allocated to the first and fourth functions F1 and F4 as the candidate functions may be fetched from the host 300.

In an embodiment, the order in which commands are fetched from the host 300 between the first and fourth functions F1 and F4 may be determined based on the available traffics of the first and fourth functions F1 and F4. In other words, as for the priority order of the first and fourth functions F1 and F4, the fourth function F4 of which the available traffic is highest as 6 may be determined as a first rank, and the first function of which the available traffic is 2 may be determined as a second rank.

In another embodiment, the order in which commands are fetched from the host 300 between the first and fourth functions F1 and F4 may be determined using round robin or weighted round robin with urgent priority class.

At the time t2, referring to the traffic table 211b described with reference to FIG. 3, the counted amount for each of the first, third, and fourth functions F1, F3, and F4 is less than the threshold value, and hence the first, third, and fourth functions F1, F3, and F4 may be determined as the candidate functions. The counted amount for the second function F2 is greater than or equal to the threshold value, and hence the second function F2 may be determined as the waiting function. Therefore, only commands allocated to the first, third, and fourth functions F1, F3, and F4 as the candidate functions may be fetched from the host 300.

In an embodiment, as for the priority order of the first, third, and fourth functions F1, F3, and F4, the first function of which the available traffic is highest is 4 may be determined as a first rank, the fourth function F4 of which the available traffic is 3 may be determined as a second rank, and the third function F3 of which the available traffic is 2 may be determined as a third rank.

As described with reference to FIG. 4, each of the multi-functions may be determined as the candidate function or the waiting function, based on a result obtained by comparing the counted amount for each function with the threshold value. When a function is determined as the candidate function, a new command allocated to the function is fetched from the host 300, and data about the fetched command is processed. Therefore, the resource occupancy of the PCIe device 50 of the function may become high. When a function is determined as the waiting function, any new command allocated to the function is not fetched from the host 300, and only data about the existing command is processed. Therefore, the resource occupancy of the PCIe device 50 of the function may become low.

In accordance with the embodiment described with reference to FIG. 4, a resource of the PCIe device 50 is uniformly used for each function, and thus Quality of Service (QoS) with respect to the host 300 for each function can be efficiently achieved.

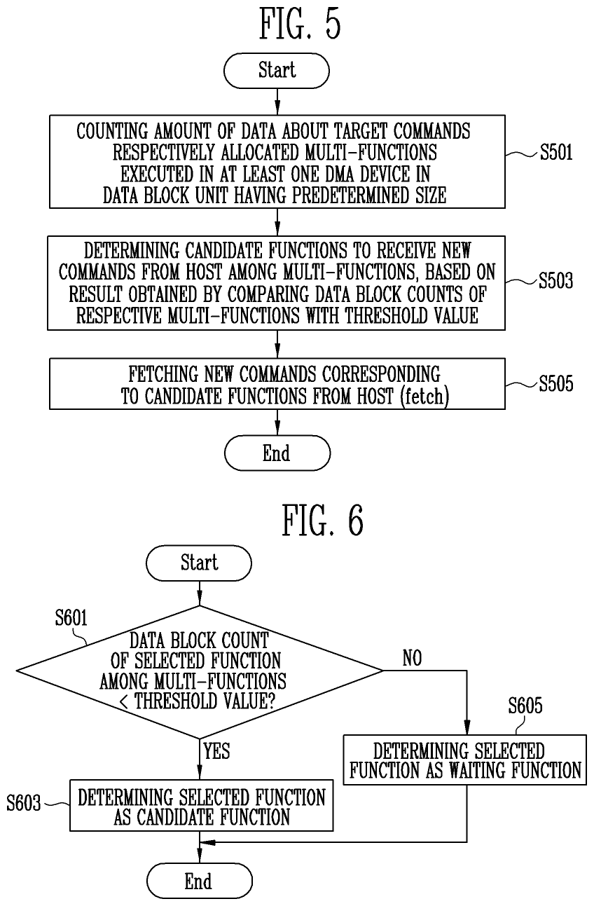

FIG. 5 is a flowchart illustrating an operation of the PCIe device in accordance with an embodiment of the present disclosure.

Referring to FIG. 5, in operation S501, the PCIe device may count, in the units of data blocks, an amount of data about target commands respectively allocated to multi-functions executed in at least one DMA devices.

In operation S503, the PCIe device may determine candidate functions to receive new commands from the host among the multi-functions, based on a result obtained by comparing the counted amount for each of the multi-functions with a threshold value.

In operation S505, the PCIe device may fetch the new commands allocated to the candidate functions from the host.

FIG. 6 is a flowchart illustrating an operation of the PCIe device in accordance with an embodiment of the present disclosure.

Referring to FIG. 6, in operation S601, the PCIe device may determine whether the counted amount for a selected function among multi-functions is less than a threshold value. When the counted amount is less than the threshold value as a determination result, the PCIe device may proceed to operation S603. When the counted amount is greater than or equal to the threshold value as a determination result, the PCIe device may proceed to operation S605.

In the operation S603, the PCIe device may determine the selected function as the candidate function.

In the operation S605, the PCIe device may determine the selected function as the waiting function.

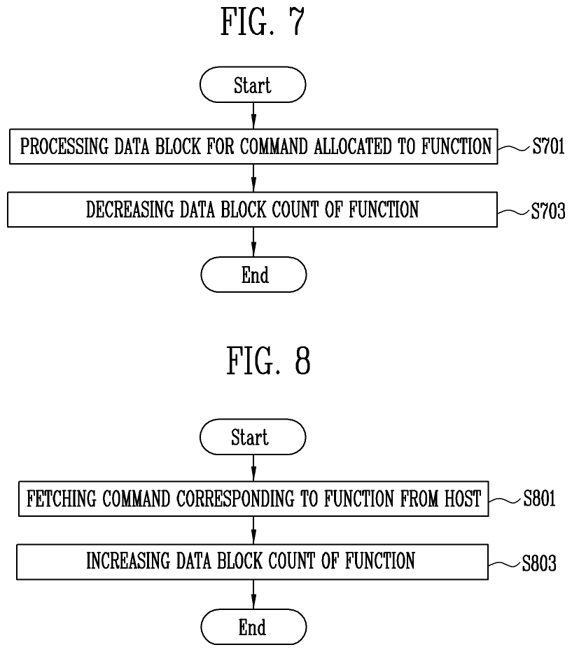

FIG. 7 is a flowchart illustrating an operation of the PCIe device in accordance with an embodiment of the present disclosure.

Referring to FIG. 7, in operation S701, the PCIe device may process, in the units of data blocks, data about a command allocated to a function.

In operation S703, the PCIe device may decrease the counted amount by as many as a number of processed data blocks.

FIG. 8 is a flowchart illustrating an operation of the PCIe device in accordance with an embodiment of the present disclosure.

Referring to FIG. 8, in operation S801, the PCIe device may fetch a command allocated to a function from the host.

In operation S803, the PCIe device may increase the counted amount for the function by as many as a number obtained by converting, in the units of data blocks, an amount of data about the fetched command.

In accordance with the present disclosure, there is provided a PCIe device for providing uniform QoS for each function, and a computing system including the PCIe device.

While the present disclosure has been shown and described with reference to certain embodiments thereof, it will be understood by those skilled in the art that various changes in form and details may be made therein without departing from the spirit and scope of the present disclosure as defined by the appended claims and their equivalents. Therefore, the scope of the present disclosure should not be limited to the above-described embodiments but should be determined by not only the appended claims but also the equivalents thereof.

In the above-described embodiments, all operations may be selectively performed or part of the operations may be omitted. In each embodiment, the operations are not necessarily performed in accordance with the described order and may be rearranged. The embodiments disclosed in this specification and drawings are only examples to facilitate an understanding of the present disclosure, and the present disclosure is not limited thereto. That is, it should be apparent to those skilled in the art that various modifications can be made on the basis of the technological scope of the present disclosure.

The embodiments of the present disclosure have been described in the drawings and specification. Although specific terminologies are used here, those are only to describe the embodiments of the present disclosure. Therefore, the present disclosure is not restricted to the above-described embodiments and many variations are possible within the spirit and scope of the present disclosure. It should be apparent to those skilled in the art that various modifications can be made on the basis of the technological scope of the present disclosure in addition to the embodiments disclosed herein and the following claims. Furthermore, the embodiments may be combined to form additional embodiments.

What is claimed is:

1. A Peripheral Component Interconnect express (PCIe) device comprising:
at least one Direct Memory Access (DMA) device; and
a PCIe controller configured to:
count, in units of data blocks each having a predetermined size, an amount of data about target commands respectively allocated to multi-functions executed in the at least one DMA device, and
determine, among the multi-functions, candidate functions to receive new commands from a host based on a result obtained by comparing the counted amount for each of the multi-functions with a threshold value.

2. The PCIe device of claim 1,
wherein the PCIe controller includes:
a traffic manager configured to count the amount for each of the multi-functions and store a traffic table including the counted amount for each of the multi-functions;
a function scheduler configured to determine the candidate functions, based on the result obtained by comparing the counted amount for each of the multi-functions with the threshold value; and
a command processor configured to fetch the new commands allocated to the candidate functions from the host and process, in the units of data blocks, the data about the target commands.

3. The PCIe device of claim 2, wherein the traffic manager is further configured to update the traffic table when the command processor processes the data about the target commands.

4. The PCIe device of claim 2, wherein the traffic manager is further configured to update the traffic table when the command processor fetches the new commands allocated to the candidate functions.

5. The PCIe device of claim 2, wherein the function scheduler is further configured to determine, as waiting functions, functions for which each of the counted amounts is greater than or equal to the threshold value among the multi-functions.

6. The PCIe device of claim 2, wherein the function scheduler determines, as the candidate functions, functions for which each of the counted amounts is less than the threshold value among the multi-functions.

7. The PCIe device of claim 6, wherein the traffic manager is further configured to calculate available traffics of the candidate functions based on a result obtained by comparing the counted amount for each of the candidate functions with the threshold value.

8. The PCIe device of claim 7, wherein the function scheduler is further configured to set a priority order between the candidate functions based on the available traffics of the candidate functions.

9. The PCIe device of claim 5, wherein the command processor is further configured to provide the host with completion information on a command about which the command processor completes the processing of the data among the target commands.

10. The PCIe device of claim 1, wherein the at least one DMA device includes at least one of a Non-Volatile Memory express (NVMe) device, a Solid State Drive (SSD) device, an Artificial Intelligence Central Processing Unit (AI CPU), an Artificial Intelligence System on Chip (AI SoC), an Ethernet device, a sound card, and a graphic card.

11. A method for operating a Peripheral Component Interconnect express (PCIe) device including at least one Direct Memory Access (DMA) device, the method comprising:
counting, in units of data blocks each having a predetermined size, an amount of data about target commands respectively allocated to multi-functions executed in the at least one DMA device; and
determining, among the multi-functions, candidate functions to receive new commands from a host based on a result obtained by comparing the counted amount for each of the multi-functions with a threshold value.

12. The method of claim 11, wherein the determining of the candidate functions includes determining, as the candidate functions, functions for which each of the counted amounts is less than the threshold value among the multi-functions.

13. The method of claim 11, further comprising:
calculating available traffics of the candidate functions based on a result obtained by comparing the counted amount for each of the candidate functions with the threshold value; and
setting a priority order between the candidate functions based on the available traffics of the candidate functions.

14. The method of claim 12, further comprising determining, as waiting functions, functions for which each of the counted amounts is greater than or equal to the threshold value among the multi-functions.

15. The method of claim 11, further comprising fetching the new commands allocated to the candidate functions from the host.

16. The method of claim 15, further comprising updating the counted amounts for the candidate functions after the fetching.

17. The method of claim 11, further comprising processing, in the units of data blocks, the data about the target commands.

18. The method of claim 17, further comprising updating the counted amounts for the respective multi-functions after the processing.

19. The method of claim 17, further comprising providing the host with completion information on a command about which the processing of the data is completed among the target commands.

20. The method of claim 11, wherein the at least one DMA device includes at least one of a Non-Volatile Memory express (NVMe) device, a Solid State Drive (SSD) device, an Artificial Intelligence Central Processing Unit (AI CPU), an Artificial Intelligence System on Chip (AI SoC), an Ethernet device, a sound card, and a graphic card.
